(19) United States
(12) Patent Application Publication
(10) Pub. No.: US 2017/0197700 A1
(43) Pub. Date: Jul. 13, 2017

(54) ELECTRIC DISTRIBUTED PROPULSION AND HIGH LIFT SYSTEM

(71) Applicant: NORTHROP GRUMMAN SYSTEMS CORPORATION, FALLS CHURCH, VA (US)

(72) Inventor: BARNABY S. WAINFAN, LONG BEACH, CA (US)

(21) Appl. No.: 14/992,951

(22) Filed: Jan. 11, 2016

(51) Int. Cl. B64C 3/32; B64D 27/24; B64C 9/00

(52) U.S. Cl. CPC B64C 3/32; B64C 9/00; B64D 27/24

(57) ABSTRACT

An electric propulsion and lift system for an aircraft that includes a plurality of electric motor/propeller assemblies on the flaps of the aircraft so that when the flaps are deflected for take-off and landings, the propellers are directed downward to provide thrust for power lift and increased airflow over the wing for aerodynamic lift. The motor/propeller assemblies are spaced apart and positioned along the entire length of the flaps to provide a distributed airflow.

### BACKGROUND

Field

This invention relates generally to a propulsion and lift system for an aircraft and, more particularly, to an electric propulsion and lift system for an aircraft, where the system includes a plurality of electric motor/propeller assemblies mounted to a flap at the trailing edge of the wings on the aircraft so that the motor and propeller deflect downward with the flap to provide both power lift and augmented aerodynamic lift.

Discussion

Aerodynamic lift is provided by an airfoil that has a particular curved shape so that air flows under the airfoil relatively straight and over the airfoil along a curve to provide higher pressure under the wing to provide the lift. For an aircraft the wings are the airfoil. Therefore, the aircraft wings must travel through the air at some speed depending on the weight and drag on the aircraft to provide suitable aerodynamic lift for fight. Usually, an aircraft wing will include flaps pivotally mounted to a trailing edge of the wing that are used to alter the airflow characteristics over the wing to increase the aerodynamic lift. More particularly, when the flaps are extended they increase the curvature of the wing which raises its lift coefficient, but increases the aircraft drag, so that the aircraft can be flown at slower speeds, which allows the aircraft to take off and land at lower speeds.

There is a general desire in the aeronautics industry to reduce aircraft take-off and landing distances, while still maintaining an efficient cruise performance once the aircraft is in flight. One way of reducing and even eliminating take-off and landing distances is to provide power lift, where rotating blades typically provide downward thrust. For example, helicopters and other types of aircraft employ only power lift that allows the aircraft to take off and land vertically. However, providing only power lift requires a large amount of power depending on the aircraft payload, and thus increased cost, where the goal is typically to obtain the largest amount of lift capability with the lowest amount power. In order to provide cost/benefit advantages, it is known in the art to provide a combination of both aerodynamic lift and power lift to provide shorter take-off and landing distances, where the more power lift the aircraft has the higher the power requirements and the increased cost for the same payload.

It is known in the art to not only provide a combination of power lift and aerodynamic lift for aircraft take-off and landing, but also to employ propellers for providing power lift and increased airflow over the wing to augment the aerodynamic lift. One known aircraft design that employs this type of combined power and aerodynamic lift for an aircraft is known as the Dornier DO-29 aircraft. The Dornier aircraft includes a tilting-propeller system that provides short take-off and landing distances, where the system includes pusher propellers on each wing to provide downward thrust and enhanced lift. However, the Dornier aircraft requires complicated mechanical connections to the pusher propellers, and does not provide distribution of the propeller thrust along the wing.

### SUMMARY

The present invention discloses and describes an electric propulsion and lift system for an aircraft that includes a plurality of electric motor/propeller assemblies mounted on the flaps of the aircraft so that when the flaps are extended for take-off and landings, the propellers are directed downward to provide thrust for power lift and increased airflow over the wing for augmented aerodynamic lift. The motor/propeller assemblies are spaced apart and positioned along the entire length of the flaps to provide a distributed airflow.

Additional features of the present invention will become apparent from the following description and appended claims, taken in conjunction with the accompanying drawings.

### BRIEF DESCRIPTION OF THE DRAWINGS

FIG. 1 is a top view of an aircraft having aircraft wings, where each wing includes a flap at its trailing edge and a plurality of electric motor/propeller assemblies spaced apart along the flaps; and

FIG. 2 is a cross-sectional view through one of the wings of the aircraft showing the flap in an extended state.

### DETAILED DESCRIPTION OF THE EMBODIMENTS

The following discussion of the embodiments of the invention directed to an electric propulsion and lift system for an aircraft is merely exemplary in nature, and is in no way intended to limit the invention or its applications or uses.

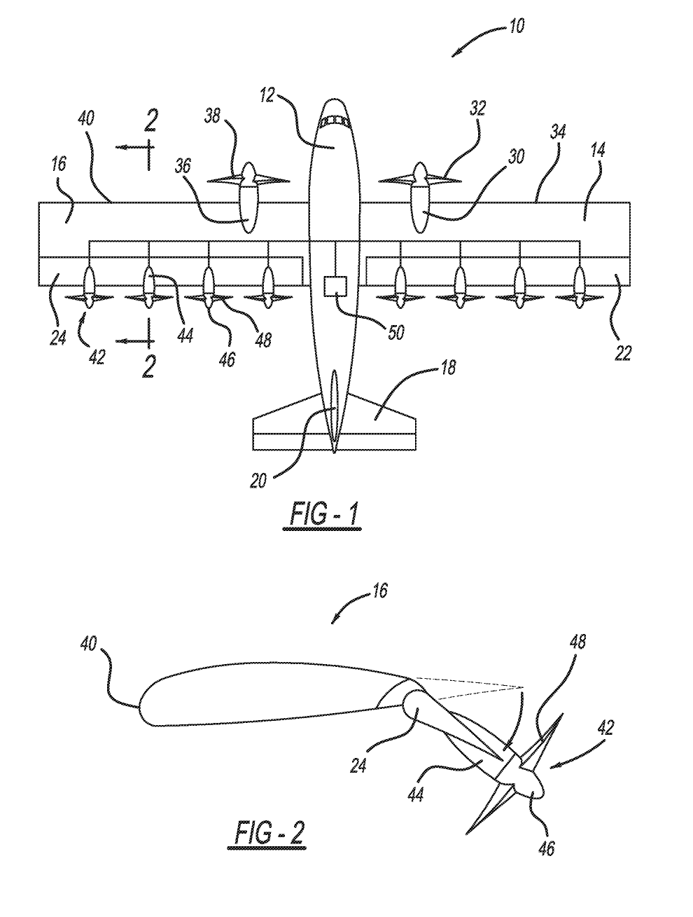

FIG. 1 is a top view of an aircraft 10 including a fuselage 12, a right wing 14 mounted to a right side of the fuselage 12, a left wing 16 mounted to a left side of the fuselage 12, a horizontal stabilizer 18 and a vertical stabilizer 20. A flap 22 is pivotally mounted to a trailing edge of the wing 14 and a flap 24 is pivotally mounted to a trailing edge of the wing 16. Further, a cruise engine 30 including a propeller 32 is mounted to a leading edge 34 of the wing 14 and a cruise engine 36 including a propeller 38 is mounted to a leading edge 40 of the wing 16. The aircraft 10 is intended to represent any aircraft suitable for an electric propulsion and lift system of the invention discussed herein, and can include single engine aircraft, multi-engine aircraft, prop aircraft, jet engine aircraft, swept-wing aircraft, straight-wing aircraft, commercial aircraft, military aircraft, etc.

The electric propulsion and lift system of the invention on the aircraft 10 includes a plurality of electric motor/propeller assemblies 42 mounted to each of the flaps 22 and 24, where each assembly 42 includes an electric motor 44 and a propeller 46 having propeller blades 48. In this embodiment, four of the assemblies 42 are mounted to each of the flaps 22 and 24. However, it is noted that this is for illustration purposes only in that the number of the assemblies 42 provided on the aircraft 10 would depend on various factors, such as the length of the flaps 22 and 24, the size of the motors 44, the size of the aircraft 10, etc.

FIG. 2 is a cross-sectional view through line 2-2 of the wing 16 showing the flap 24 in an extended orientation at a certain angle, where the assembly 42 is also angled downward. When the aircraft 10 is in its take-off or landing posture, the flaps 22 and 24 will be extended some amount depending on the aircraft type to provide additional aerodynamic lift as discussed above. When the flaps 22 and 24 are extended, and the propellers 46 are rotating, airflow is directed downward relative to the orientation of the aircraft 10 to provide some power lift. Further, rotation of the propellers 46 draws airflow over the wings 14 and 16 and the flaps 22 and 24 in addition to the airflow over the wings 14 and 6 caused by movement of the aircraft 10 to increase the aerodynamic lift, where the propellers 46 cause the direction of the flow to be more downward further increasing the lift capability. Traditionally, when the flaps 22 and 24 are extended, airflow over the wings 14 and 16 of the aircraft 10 is directed downward some amount which provides additional lift. However, if the deflection of the flaps 22 and 24 is greater than some amount, the airflow will not follow the corner where the flap 22 or 24 pivots relative to the wing 14 or 16, creating airflow turbulence. By drawing air over the wings 14 and 16 using the propellers 46, the amount that the flaps 22 and 26 can be extended before the airflow separates at the corner is increased, which provides increased aerodynamic lift in addition to the downward thrust provided by the propellers 46.

When the aircraft 10 takes off and has achieved a certain air speed, the flaps 22 and 24 are no longer needed for added lift, and they are retracted to provide a better in-flight cruise orientation. The engines 30 and 36 provide the main thrust that propels the aircraft 10 to provide airflow over the wings 14 and 16 for aerodynamic lift. When the aircraft 10 is in its cruise configuration and the flaps 22 and 24 are retracted, the electric motors 44 can be turned off because they are no longer needed to provide lift, and can be feathered or folded to reduce drag. In an alternate embodiment, the motors 40 can be left on, so that the propellers 46 provide additional thrust for aircraft cruising, which allows the size of the engines 30 and 36 to be reduced. In yet another embodiment, for certain aircraft designs it may be possible to eliminate the cruise engines 30 and 36, where the electric motor/propeller assemblies 42 provide all of the lift and thrust capabilities for the aircraft 10.

For some designs, all of the motors 44 may be the same size. In other designs, the motors 44 can be of different sizes, where, for example, some of the motors 44 may only be run for aircraft flight during cruising operations, and where all of the motors 44 may be operational for take-off and landing. Further, because the motors 44 can be operated at different speeds, and thus provide different lift characteristics of the wings 14 and 16, control of the motors 44 can be used to rotate the aircraft 10 for roll control, such as for turning, where it may be desirable to lift one of the wings 14 or 16 more than the other for landing or otherwise. Further, it may be desirable to provide a different number of the blades 48 on the propellers 46 for noise control or otherwise.

As mentioned, the motors 44 are electric motors, which can be powered by any suitable power source, represented generally as power source 50. In one non-limiting design, the power source 50 is a generator that is operated by rotation of the propellers 32 and 38 on the engines 30 and 36. Alternately, the power source 50 can be one or more batteries, where the batteries 52 are charged by the engines 30 or 36 or externally charged when the aircraft 10 is on the ground. In yet another embodiment, it is possible to provide a separate battery in association with each of the motors 44.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An aircraft comprising:
a fuselage;
a first wing mounted on one side of the fuselage and a second wing mounted on an opposite side of the fuselage, each of the wings including a trailing edge having a flap pivotally mounted thereto; and
a plurality of electric motor/propeller assemblies mounted to each of the flaps and being positioned when the flaps are extended so that propellers on the assemblies are oriented downward to provide power lift and increased aerodynamic lift.

2. The aircraft according to claim 1 wherein the plurality of motor/propeller assemblies mounted to each flap are spaced apart and extend an entire length of the flaps.

3. The aircraft according to claim 1 further comprising main cruise engines that provide thrust for the aircraft.

4. The aircraft according to claim 3 wherein the engines are mounted to a leading edge of the wings.

5. The aircraft according to claim 1 wherein the plurality of electric motor/propeller assemblies are the only propulsion devices on the aircraft.

6. The aircraft according to claim 1 further comprising a power source for providing electrical power to the motor/propeller assemblies.

7. The aircraft according to claim 6 wherein the power source is a generator.

8. The aircraft according to claim 6 wherein the power source is at least one battery.

9. The aircraft according to claim 8 wherein a separate battery is provided for each motor/propeller assembly.

10. The aircraft according to claim 1 wherein the plurality of electric motors are the same size.

11. The aircraft according to claim 1 wherein the plurality of electric motor/propeller assemblies have different sizes.

12. The aircraft according to claim 1 wherein each propeller has a certain number of blades as determined by its location on the flap.

13. A propulsion and lift system for an aircraft comprising a plurality of electric motor/propeller assemblies mounted to a flap positioned at a trailing edge of a wing on the aircraft, said plurality of electric motor/propeller assemblies being positioned when the flap is extended so that propellers on the assemblies are oriented downward to provide power lift and increased aerodynamic lift.

14. The system according to claim 13 wherein the plurality of motor/propeller assemblies mounted to the flap are spaced apart and extend an entire length of the flap.

15. The system according to claim 13 wherein the plurality of electric motor/propeller assemblies are the only propulsion devices on the aircraft.

16. The system according to claim 13 further comprising a power source for providing electrical power to the motor/propeller assemblies.

17. The system according to claim 16 wherein the power source is a generator.

18. The system according to claim 16 wherein the power source is at least one battery.

19. The system according to claim 18 wherein a separate battery is provided for each motor/propeller assembly.

20. The system according to claim 13 wherein the plurality of electric motors are the same size.
